(19) United States
(12) Patent Application Publication
(10) Pub. No.: US 2012/0280031 A1
(43) Pub. Date: Nov. 8, 2012

(54) QR CODES USED IN TELEPHONE BOOK ADVERTISING

(76) Inventors: Brad Nelson, Grand Rapids, MI (US); Tony Vermaas, Grand Rapids, MI (US); Andrew Swanson, Grand Rapids, MI (US); Julie Schrebe, Grand Rapids, MI (US)

(21) Appl. No.: 13/465,693

(22) Filed: May 7, 2012

Related U.S. Application Data
(60) Provisional application No. 61/483,340, filed on May 6, 2011.

(51) Int. Cl. G06Q 90/00

(52) U.S. Cl. 235/375

(57) ABSTRACT

A method for using a quick response (QR) code in printed materials includes determining a long URL for use with a product or service (501). A short URL is created based on the long URL (503). The short URL is then included within a quick response (QR) code (505). Next, the QR code is used in connection with printed matter in a channel of trade (507). Upon scanning the code (509), the user is redirected to the long URL based on the short URL at a remote computer system (511, 513). Finally, an advertiser or business owner can determine if the QR code should be redeployed in the same or a different channel of trade based on the use and pass though of the short URL (517, 523, 525).

### CROSS-REFERENCE TO RELATED APPLICATION

This application claims priority under 35 U.S.C. §119(e) to U.S. Provisional Patent Application No. 61/483,340, filed May 6, 2011, entitled “METHOD FOR USING QUICK RESPONSE (QR) CODES IN CONNECTION WITH TELEPHONE ADVERTISING MATERIALS”, which is herein incorporated by reference in its entirety.

### FIELD OF THE INVENTION

The present invention relates generally to two-dimensional quick response (QR) codes and more particularly a business method for using QR codes in connection with print advertising.

### BACKGROUND OF THE INVENTION

The acronym QR is derived from the term Quick Response. The company Denso Wave (a division of Toyota) originally coined the term QR as the creator of a unique two-dimensional code that was intended to be electronically scanned at substantially high speed for use with its parts inventory. Although QR codes originated in Japan, these codes have only recently begun to become popular in other regions of the world such as the Middle East, Europe and the United States.

For many years, standard single line barcodes have been used on many commercial products in the marketplace. The use of bar codes on various products offer the user many advantages. The bar codes can be quickly read, have great accuracy and are very dependable. As single line barcodes have become more accepted and used in more worldwide applications, the need for more data and character types was realized for enabling greater amounts of information to be stored in the code. As a result, developers began trying to expand on the current amount of bars within the standard line barcode. Although it was determined that changing character positioning could allow for further data capacities, as research and development progressed, a number of problems arose when trying to expand the amount of data tied to a single line barcode. Moreover, increasing the character size or positioning caused considerable reading and printing problems. As a result, two-dimensional (2D) barcodes, like QR codes, were created.

Although initially used for tracking parts in vehicle manufacturing, QR codes are now used in a much broader context. QR codes have both commercial tracking applications as well as convenience-oriented applications aimed at mobile phone users (known as mobile tagging). QR codes that store various addresses and URLs may appear in magazines, signs, buses, business cards or on just about any object about which users might need more information. This enables more information to be delivered than the space available on the media in which it is printed. Users with a camera phone, equipped with the correct reader software application, can scan the image of the QR code to display text, contact information, connect to a wireless network, or open a web page in the phone's browser.

Recently, QR codes have become more prevalent in their use by marketing professionals by integrating them into both traditional and interactive campaigns. Media where QR codes have been deployed include, but are not limited to, billboard ads, marketing campaigns, in-store displays, event ticketing and tracking, trade-show management, business cards, print ads, contests, direct mail campaigns, websites, email marketing, and couponing. QR codes are of particular interest to marketers since the codes give them the ability to measure response rates with a high degree of precision. This allows for efficient and quantifiable ROI (return on investment) calculations to be used in ad expense justification and response rate measurement. For example, commercial printers offer QR code services that include creation of the QR code, printing onto direct mail pieces (or any other printed material) and back end tracking on the usage of each code. Through a proprietary system, some marketers also offer PURL's (Personalized URL's), which allow a business to create unique QR codes for each user that they are postal mailing a printed item. The tracking then can very specifically identify each individual consumer when they scan their specific code and take them to a personalized landing page that is tailored to their specific needs. This process offers an advantage to the advertiser allowing them to market down to the actual individual consumer level. The user experience is customized while tracking each user's one-to-one response at an extremely affordable price point.

As seen in prior art FIG. 1, the QR code appears as type of matrix barcode (or two-dimensional code) that can be used in connection with smart mobile phones. The QR code is readable by a dedicated QR barcode reader, i.e., software that is installed on the smart phone and used in connection with the imaging device or camera built into the device. The code consists of a plurality of black modules that are arranged in a square pattern on a white background. Data that is encoded in the QR code can be such information as text, a uniform resource locator (URL) or other records. In use, the QR code can be pointed for use in browsing a website, bookmarking a website, making a telephone call, sending a short message, sending an email, creating a Microsoft vCard, creating a meCard, creating calendar events, creating map URL, creating geological coordinates, using Twitter, indicating chat sessions, connecting to WiFi networks and/or reading plain formatted text on your mobile device.

Additionally, QR codes can be used in connection with advertising and offer a substantial benefit in view of the QR code's amount of information in a small space when used in connection with a smart phone camera. The potential revenue streams for QR codes are unlimited in that they can be printed on just about any surface or product and can be easily scanned and used via a smart phone. The pace of smart phone adoption and activation is expected to grow rapidly in the coming years. Accordingly, business plans that can adapt and capitalize on the growing importance of QR codes in consumer's lives will become highly important and relevant to their revenue streams moving forward.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is prior art diagram showing a QR code that can be used in connection with smart mobile phones and other electronic devices.

FIG. 2 is a screen shot giving the user instructions on downloading Scanlife scanning software to the mobile phone.

FIG. 3 is a screen shot showing a map generated using a QR code.

FIG. 4 is screen shot showing contact information obtained using a QR code.

FIG. 5 is a flow chart diagram illustrating the business method using QR codes according to an embodiment of the present invention.

FIG. 6 is screen shot illustrating a coupon as used in connection with the method of the present invention.

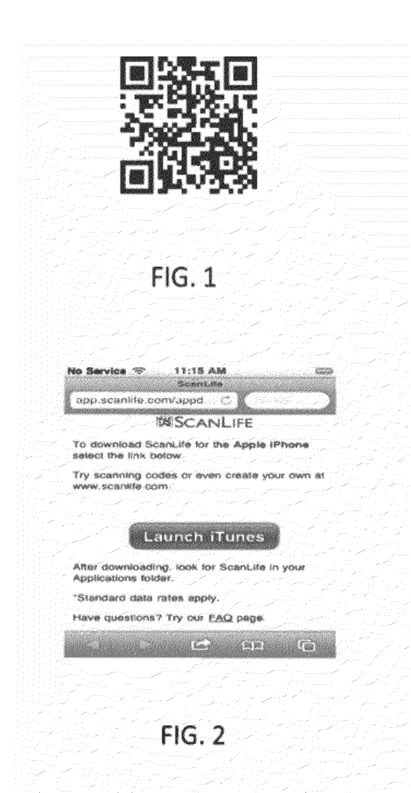

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE PREFERRED EMBODIMENTS

Before describing in detail embodiments that are in accordance with the present invention, it should be observed that the embodiments reside primarily in combinations of method steps related to utilizing QR codes in advertising publications and other business uses. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

One application of using the method of the present invention is in connection with telephone book advertising or other printed matter. Generally, the method includes placing a QR code on the front cover of a telephone book or other printed advertising. The printed matter explains with textual information how the user can obtain the proper scanning software on their mobile phone or other device. For example, ScanLife software can be downloaded as an application or “app” on their phone that allows the user the ability to capture or “scan” images using the camera phone. Although other brands of software are available, the ScanLife software is often considered the best and most recognized smart phone application for this purpose. The Scanlife software works to automatically detect the phone's manufacture and then loads the applicable scanning software onto the device.

As seen in FIG. 2, once the Scanlife software has been loaded on the smart phone, it simply needs to be opened and pointed at the QR code. Textual information may also be included at the perimeter of the QR code for allowing the user to easily identify an advertiser or business through textual informal. Once the image is captured of the code, the scanning software will decode the information and provide the applicable response. The QR code forwards the user to an advertiser's landing page which explains the QR code and how it can be used for advertising or other purposes. Thus, the method of the present invention also allows a simple mobile landing page to be cleanly loaded on a user's mobile phone while still conveying the message of how it can be used. This works to enhance the overall user experience in shopping for products and/or services. The method as described herein includes offering advertisers various options for landing pages with the thought the advertiser can redirect persons encountering the QR code on printed matter allowing them to scan the QR code at any time. This creates a consistent user experience and expectation when seeking out information from a telephone directory or other printed publication. It also allows an opportunity to revisit each QR code campaign on a periodic basis with participating advertisers by offering the option of other alternative locations and pricing.

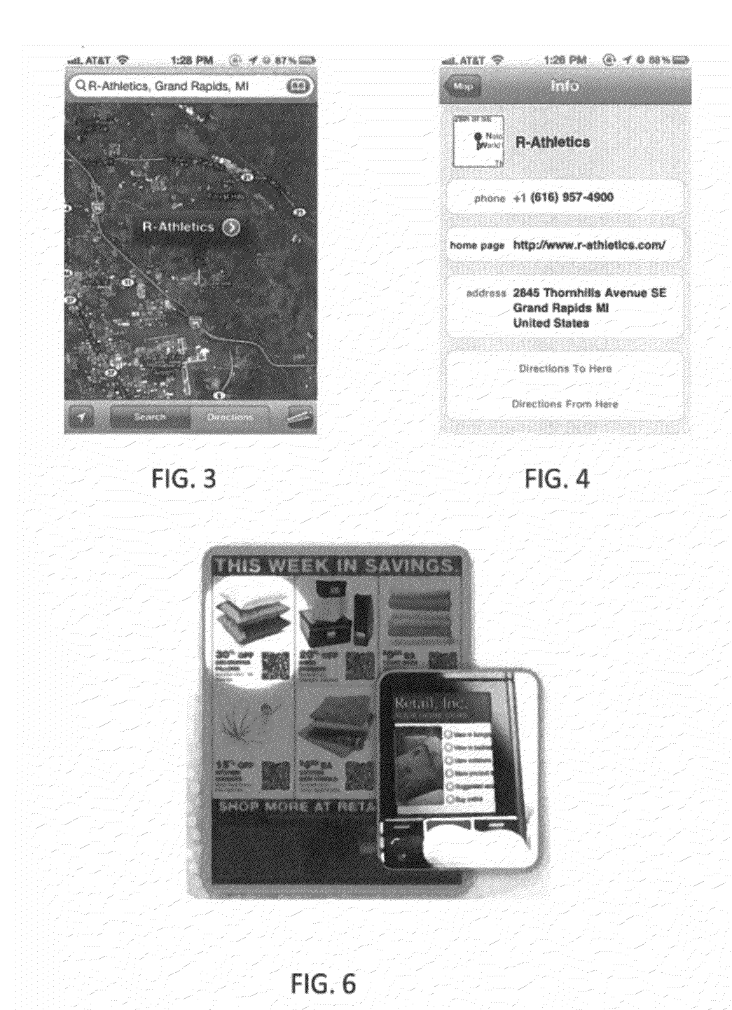

Additional options for applications using QR codes when using a printed directory include but are not limited to a providing the user with a web address, Google Map, video, online PDF or telephone number. Although present technology rules prohibits forwarding a QR code out to a Google Map, the future use of these types of techniques will offer the most efficient landing page since this method will cleanly load content on the smart phone in a error free manner Moreover, this type of second level use beyond the map can also include placing a telephone call, visiting an advertiser's website, sending an email, pulling directions to their location and user reviews. As an example, FIG. 3 shows a screen shot from an Apple iPhone illustrating the use of a directed QR code to a Google map for displaying a business listing. This functionality essentially achieves a “mobile” type app when interacting with QR codes without actually having to develop in-house web pages. Further, it allows the advertiser to “value add” in one additional way since it can work with those advertisers that have not verified their Google Place listings or claimed and managed their listings via a Google Business account.

FIG. 4 illustrates an initial landing page from the QR code to provide business contract information. This gives the user all of the options to interact with a QR code advertiser. QR codes can be added to all advertising “filler” that can point the user to various web sites. This type of use has the objective of allowing both adults and children to experience the functionality of the QR codes when encountering them in day-to-day living. It also gives users the desire to scan the codes in order to see where they might point. This thought process enables the QR code to always point to a marketer's mobile page or advertising site. If unable to easily scan a QR code, consumers would lose interest and would because the experience is not interesting or fulfilling. The method of the present invention allows the user to scan a QR code as an experiment so it can be easily tested and “tried out”.

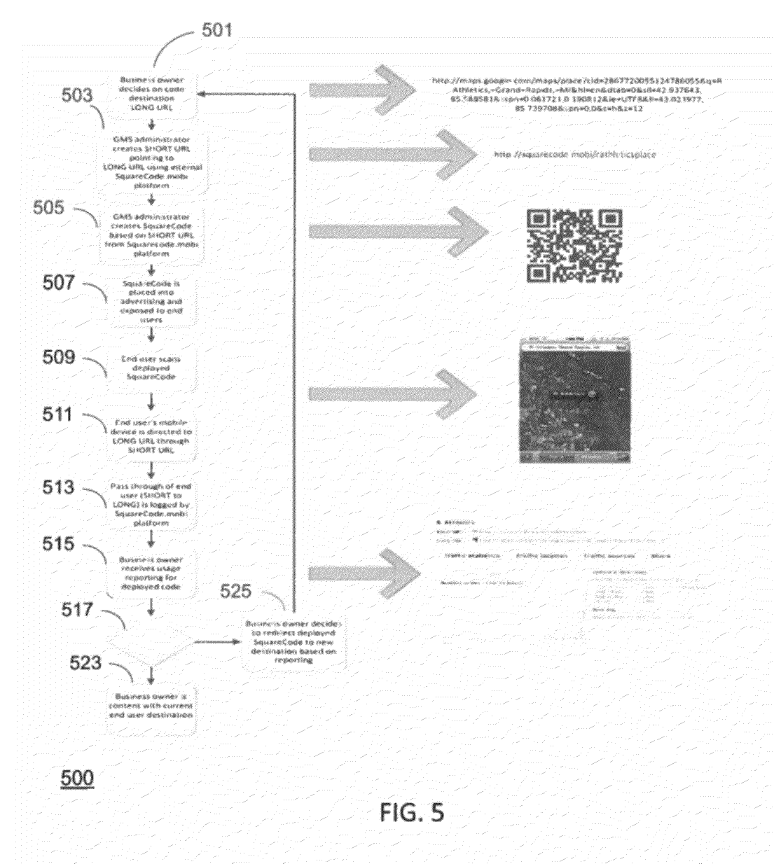

As discussed with regard to FIG. 5 herein, the present method includes the use of a URL shortener. The URL shortener enables those using the QR code to take any web landing page having a substantially long URL and create a shortened URL based on the original lengthy web address. A sever or host can then redirect the scanned QR code to a final landing spot. Moreover, creating the shortened URL allows the advertiser to count and time stamp each scan which takes place. This count and stamp functionality provides analytics and other reports to each advertiser on a periodic basis allowing them to make changes based on use.

FIG. 5 illustrates a flow chart diagram showing the steps of the business method in accordance with an embodiment of present invention. The business method using a QR code 500, according to an embodiment of the invention begins where a business owner decides on a QR code destination 501 that might include a substantially long URL. A global management system (GMS) administrator then creates 503 a short URL that points to the long URL using a QR code mobile platform. The GMS administrator than creates 505 a QR code that incorporates the short URL. The QR code is then placed into advertising or other printed matter so it can be exposed to potential users 507. When encountered by a user, the QR code is scanned 509 with their mobile device such as a smart phone camera. The short URL that is encoded in the QR code directs the user's mobile device to the long URL hosted on a remote server 511. The mobile platform at the remote server then records and/or logs the pass through by the user 513. Thereafter, a business owner can receive a usage report that can give indication or other clues on the best locations to use and display the QR code 515. This gives the business owner an opportunity to determine 523 if the QR code should be redeployed 525 in a different channel of trade or if the results are adequate to continue the QR code at its current location and/or channel of trade 527.

In a future use, the URL shorteners may also allow the redirection of a QR code that is tied to a phone number. This will allow those scans to be tracked. A scan-to-call feature would take a user to a landing page where the user can “click to call”. This allows the number of calls to be accurately counted. Thus, the ultimate goal of using QR codes in telephone, directories, business directories and other business applications is shifting the demographic, use and interaction of these directories. This provides for the extension of the life and viability of a business directory for greater periods of time, e.g., 5 to 10 years. Because directories offer a wealth of rich content, QR codes will be able to enhance that information and change the overall user experience with the directory.

In other applications, a hosted mobile landing page can be created for restaurant menus. A user can scan a QR code at the front of a restaurant heading in the directory that is tied to this landing page. The user can then browse multiple menus and then click to call any participating restaurant for reservations or ordering. Still other applications include using QR codes that take a consumer to a coupon for a particular business. FIG. 7 is a screen shot that illustrates a coupon that might be encountered using such a feature. A customer developed or approved PDF of the coupon can be loaded and hosted on an advertiser's server. Once the user scans the applicable QR code, a PDF of the coupon can be download that will show a participating business for redemption purposes. The combination QR code and mobile landing page/sites can be developed for any desired advertiser. Because of the flexibility in which these codes can be used, and the results they produce, QR codes are an excellent solution for businesses enabling them to extend the life of printed yellow page products, directories and other printed advertising. This allows the business to branch out into different revenue streams for increasing its overall profitability.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A method for using a quick response (QR) code in printed materials comprising the steps of:
determining a long URL for use with a product or service;
creating a short URL based on the long URL;
including the short URL within a quick response (QR) code;
utilizing the QR code in connection with printed matter in a channel of trade;
redirecting the user to the long URL based on the short URL at a remote computer system; and
determining if the QR code should be redeployed in the same or a different channel of trade.

2. A method for using QR code as in claim 1, wherein the printed matter is the telephone book yellow pages.

3. A method for using a QR code as in claim 1, wherein the remote computer system is a marketing server.

4. A method for using a QR code as in claim 1, further comprising the step of:
utilizing a using report to determine if the QR code for determining if the QR code is to be redeployed in a new location.

5. A method for using a QR code as in claim 1, wherein the QR code includes textual information for determining the author of the QR code.

6. A method for using a QR code as in claim 5, wherein the textual information is printed about the perimeter of the QR code.
